(19) United States
(12) Patent Application Publication
(10) Pub. No.: US 2008/0255868 A1
(43) Pub. Date: Oct. 16, 2008

(54) Subscription-Based Private Civil Security Facilitation Method and Apparatus

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 12/047,130

(22) Filed: Mar. 12, 2008

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006.
Application No. 11/381,265 is a continuation-in-part of application No. 11/381,277, filed on May 2, 2006.
Application No. 11/381,277 is a continuation-in-part of application No. 11/383,022, filed on May 12, 2006.
Application No. 11/383,022 is a continuation-in-part of application No. 11/420,594, filed on May 26, 2006.
Application No. 11/420,594 is a continuation-in-part of application No. 11/421,694, filed on Jun. 1, 2006.
Application No. 11/421,694 is a continuation-in-part of application No. 11/423,594, filed on Jun. 12, 2006.
Application No. 11/423,594 is a continuation-in-part of application No. 11/425,043, filed on Jun. 19, 2006.
Application No. 11/425,043 is a continuation-in-part of application No. 11/426,231, filed on Jun. 23, 2006.
Application No. 11/426,231 is a continuation-in-part of application No. 11/456,472, filed on Jul. 10, 2006.
Application No. 11/456,472 is a continuation-in-part of application No. 11/461,605, filed on Aug. 1, 2006.
Application No. 11/461,605 is a continuation-in-part of application No. 11/461,624, filed on Aug. 1, 2006.
Application No. 11/461,624 is a continuation-in-part of application No. 11/462,795, filed on Aug. 7, 2006.
Application No. 11/462,795 is a continuation-in-part of application No. 11/462,845, filed on Aug. 7, 2006.
Application No. 11/462,845 is a continuation-in-part of application No. 11/464,751, filed on Aug. 15, 2006.
Application No. 11/464,751 is a continuation of application No. 11/464,764, filed on Aug. 15, 2006.
Application No. 11/464,764 is a continuation-in-part of application No. 11/464,788, filed on Aug. 15, 2006.
Application No. 11/464,788 is a continuation-in-part of application No. 11/464,799, filed on Aug. 15, 2006.
Application No. 11/464,799 is a continuation-in-part of application No. 11/465,063, filed on Aug. 16, 2006.
Application No. 11/465,063 is a continuation-in-part of application No. 11/466,727, filed on Aug. 23, 2006.
Application No. 11/466,727 is a continuation-in-part of application No. 11/466,953, filed on Aug. 24, 2006.
Application No. 11/466,953 is a continuation-in-part of application No. 11/470,156, filed on Sep. 5, 2006.
Application No. 11/470,156 is a continuation-in-part of application No. 11/531,651, filed on Sep. 13, 2006.
Application No. 11/531,651 is a continuation-in-part of application No. 11/532,461, filed on Sep. 15, 2006.
Application No. 11/532,461 is a continuation-in-part of application No. 11/535,021, filed on Sep. 25, 2006.
Application No. 11/535,021 is a continuation-in-part of application No. 11/535,282, filed on Sep. 26, 2006.
Application No. 11/535,282 is a continuation-in-part of application No. 11/537,469, filed on Sep. 29, 2006.
Application No. 11/537,469 is a continuation-in-part of application No. 11/539,798, filed on Oct. 9, 2006.
Application No. 11/539,798 is a continuation-in-part of application No. 11/539,861, filed on Oct. 9, 2006.
Application No. 11/539,861 is a continuation-in-part of application No. 11/548,191, filed on Oct. 10, 2006.
Application No. 11/548,191 is a continuation-in-part of application No. 11/549,874, filed on Oct. 16, 2006.
Application No. 11/549,874 is a continuation-in-part of application No. 11/550,594, filed on Oct. 18, 2006.
Application No. 11/550,594 is a continuation-in-part of application No. 11/551,083, filed on Oct. 19, 2006.
Application No. 11/551,083 is a continuation-in-part of application No. 11/554,452, filed on Oct. 30, 2006.
Application No. 11/554,452 is a continuation-in-part of application No. 11/555,589, filed on Nov. 1, 2006.
Application No. 11/555,589 is a continuation-in-part of application No. 11/555,896, filed on Nov. 2, 2006.
Application No. 11/555,896 is a continuation-in-part of application No. 11/556,520, filed on Nov. 3, 2006.
Application No. 11/556,520 is a continuation-in-part of application No. 11/559,278, filed on Nov. 13, 2006.
(60) Provisional application No. 60/820,628, filed on Jul. 28, 2006.
(60) Provisional application No. 60/823,806, filed on Aug. 29, 2006.
(60) Provisional application No. 60/825,524, filed on Sep. 13, 2006.
(60) Provisional application No. 60/825,976, filed on Sep. 18, 2006.
(60) Provisional application No. 60/826,491, filed on Sep. 21, 2006.
(60) Provisional application No. 60/827,591, filed on Sep. 29, 2006.
(60) Provisional application No. 60/827,820, filed on Oct. 2, 2006.
(60) Provisional application No. 60/827,828, filed on Oct. 2, 2006.
(60) Provisional application No. 60/828,341, filed on Oct. 5, 2006.
(60) Provisional application No. 60/828,342, filed on Oct. 5, 2006.
(60) Provisional application No. 60/894,350, filed on Mar. 12, 2007.

(51) Int. Cl. G06Q 99/00

(52) U.S. Cl. 705/1

(57) ABSTRACT

A plurality of private civil security resources are provided (101). These private civil security resources comprise, at least in part, civil security provisions, civil security facilities, and civil security provisions. Consideration-based private civil security subscriptions are accepted (301) from subscribers with respect to providing civilly-catastrophic event-based access to one or more such resource. That resource is then maintained (303) pending a need to permit subscription-based access to the resource in the event of a catastrophic event.

### RELATED APPLICATIONS

This application claims the benefit of the filing date of U.S. provisional application Nos. 60/894,350 filed Mar. 12, 2007, which is hereby incorporated in their entirety herein.

This comprises a continuation-in-part of each of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265;

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BORADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624;

SUBSCRIPTION-BASED INTERMEDIATE SHORT-TERM EMERGENCY SHELTER METHOD as filed on Aug. 7, 2006 and having application Ser. No. 11/462,795;

SUBSCRIPTION-BASED CATASTROPHE-TRIGGERED RESCUE SERVICES FACILITATION METHOD USING WIRELESS LOCATION INFORMATION as filed on Aug. 7, 2006 and having application Ser. No. 11/462,845;

PRIVATELY PROVISIONED SURVIVAL SUPPLIES DELIVERY METHOD as filed on Aug. 15, 2006 and having application Ser. No. 11/464,751;

PRIVATELY PROVISIONED SURVIVAL SUPPLIES SUB UNIT-BASED DELIVERY METHOD as filed on Aug. 15, 2006 and having application Ser. No. 11/464,764;

PRIVATELY PROVISIONED SURVIVAL SUPPLIES ACQUISITION METHOD as filed on Aug. 15, 2006 and having application Ser. No. 11/464,775;

PRIVATELY PROVISIONED SURVIVAL SUPPLIES CONTENT ACQUISITION METHOD as filed on Aug. 15, 2006 and having application Ser. No. 11/464,788;

METHOD TO PRIVATELY PROVISION SURVIVAL SUPPLIES THAT INCLUDE THIRD PARTY ITEMS as filed on Aug. 15, 2006 and having application Ser. No. 11/464,799;

WASTE DISPOSAL DEVICE as filed on Aug. 16, 2006 and having application Ser. No. 11/465,063;

SUBSCRIPTION-BASED PRIVATE CIVIL SECURITY RESOURCE CUSTOMIZATION METHOD as filed on Aug. 23, 2006 and having application Ser. No. 11/466,727;

PREMIUM BASED PRIVATE CIVIL SECURITY POLICY METHODS as filed on Aug. 24, 2006 and having application Ser. No. 11/466,953;

SUBSCRIPTION-BASED MOBILE SHELTER METHOD as filed on Sep. 5, 2006 and having application Ser. No. 11/470,156;

METHOD OF PROVIDING A FLOATING LIFE-SUSTAINING FACILITY AS filed on Sep. 13, 2006 and having application Ser. No. 11/531,651;

PRIVATELY PROVISIONED SUB-UNIT-BASED SURVIVAL SUPPLIES PROVISIONING METHOD as filed on Sep. 15, 2006 and having application Ser. No. 11/532,461;

PRIVATELY PROVISIONED INTERLOCKING SUB UNIT BASED SURVIVAL SUPPLIES PROVISIONING METHOD as filed on Sep. 25, 2006 and having application Ser. No. 11/535,021;

RESOURCE CONTAINER AND POSITIONING METHOD AND APPARATUS as filed on Sep. 26, 2006 and having application Ser. No. 11/535,282;

PUBLICLY-FUNDED PRIVATELY FACILITATED ACCESS TO SURVIVAL RESOURCES METHOD as filed on Sep. 29, 2006 and having application Ser. No. 11/537,469;

ELECTRICITY PROVIDING PRIVATELY PROVISIONED SUBSCRIPTION-BASED SURVIVAL SUPPLY UNIT METHOD AND APPARATUS as filed on Oct. 9, 2006 and having application Ser. No. 11/539,798;

PREMIUM-BASED CIVILLY-CATASTROPHIC EVENT THREAT ASSESSMENT as filed on Oct. 9, 2006 and having application Ser. No. 11/539,861;

PRIVATELY MANAGED ENTERTAINMENT AND RECREATION SUPPLIES PROVISIONING METHOD as filed on Oct. 10, 2006 and having application Ser. No. 11/548,191;

METHOD TO FACILITATE PROVIDING ACCESS TO A PLURALITY OF PRIVATE CIVIL SECURITY RESOURCE as filed on Oct. 16, 2006 and having application Ser. No. 11/549,874;

METHOD OF PROVIDING BEARER CERTIFICATES FOR PRIVATE CIVIL SECURITY BENEFITS as filed on Oct. 18, 2006 and having application Ser. No. 11/550,594;

METHOD FOR CIVILLY-CATASTROPHIC EVENT-BASED TRANSPORT SERVICE AND VEHICLES THEREFOR as filed on Oct. 19, 2006 and having application Ser. No. 11/551,083;

METHOD FOR PROVIDING PRIVATE CIVIL SECURITY SERVICES BUNDLED WITH SECOND PARTY PRODUCTS as filed on Oct. 30, 2006 and having application Ser. No. 11/554,452;

SYSTEM AND METHOD FOR A PRIVATE CIVIL SECURITY LOYALTY REWARD PROGRAM as filed on Nov. 1, 2006 and having application Ser. No. 11/555,589;

SUBSCRIPTION BASED SHUTTLE METHOD as filed on Nov. 2, 2006 and having application Ser. No. 11/555,896;

METHOD AND SECURITY MODULES FOR AN INCIDENT DEPLOYMENT AND RESPONSE SYSTEM FOR FACILITATING ACCESS TO PRIVATE CIVIL SECURITY RESOURCES as filed on Nov. 3, 2006 and having application Ser. No. 11/556,520;

METHOD OF PROVIDING SURVIVAL SUPPLIES CONTAINER WITH AN ILLUMINATION APPARATUS as filed on Nov. 13, 2006 and having application Ser. No. 11/559,278;

the contents of each of which are fully incorporated herein by this reference.

### TECHNICAL FIELD

This invention relates generally to providing survival-related services.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related actions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swath of a given civil entity. Any number of natural and/or human-caused events can greatly disrupt society's infrastructure and corresponding ability to provide one or more life-sustaining resources such as water, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk survival (let alone the comfort) of their citizens in the face of most civilly-catastrophic events. On the other hand, attempting to take responsible actions to reasonably ensure one's own safety and security can become, in and of itself, nearly a full-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

As a result, many (if not most) individuals and their families are largely bereft of access to survival resources that they will need should a civilly-catastrophic event befall them. This shortcoming tends to be relatively comprehensive; most people have ready access to neither a sufficient selection of survival supplies nor a sufficient quantity. For people who do have a store of supplies set aside against such an eventuality, it can be a considerable burden to maintain and ensure the freshness, vitality, and usability of those supplies. At the same time, the same civilly-catastrophic event that occasions their need for supplies will also likely disrupt relevant supply chains enough to cause a partial or complete shortage of supplies at their local merchants. The unfortunate net result is a relatively near term severe need for a variety of survival supplies that will often go unmet for lengthy periods of time.

Such persons are also largely without many options when faced with civilly-catastrophic conditions that create a concurrent need for shelter, evacuation, and/or rescue. For example, in many cases, the only available shelter comprises a public facility such as a school, auditorium, or sports venue on the one hand or ad hoc accommodations obtained at a hotel or via a charity or one's own social network. In some cases, such options may be adequate. In many other cases, however, such options quickly prove inadequate or even dangerous in and of themselves. Even in cases where public civil security resources in the aggregate may be adequate, significant problems can arise with respect to matching and providing a proper type of resource to those who need a particular type of resource in light of a civilly-catastrophic event while simultaneously avoiding waste, confusion, or unnecessary loss.

### BRIEF DESCRIPTION OF THE DRAWINGS

The above needs are at least partially met through provision of the subscription-based private civil security facilitation method described in the following detailed description, particularly when studied in conjunction with the drawings, wherein:

FIG. 1 comprises a flow diagram as configured in accordance with various embodiments of the invention;

FIG. 2 comprises a schematic block diagram view as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a schematic block diagram as configured in accordance with various embodiments of the invention;

FIG. 6 comprises a schematic block diagram as configured in accordance with various embodiments of the invention;

FIG. 7 comprises a schematic block diagram as configured in accordance with various embodiments of the invention;

FIG. 8 comprises a schematic block diagram as configured in accordance with various embodiments of the invention;

FIG. 9 comprises a schematic block diagram as configured in accordance with various embodiments of the invention;

FIG. 10 comprises a flow diagram as configured in accordance with various embodiments of the invention;

FIG. 11 comprises a top plan block diagram view as configured in accordance with various embodiments of the invention; and

FIG. 12 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a plurality of private civil security resources are provided. These private civil security resources comprise, at least in part, civil security provisions, civil security facilities, and civil security services. By one approach, consideration-based private civil security subscriptions are accepted from subscribers with respect to providing civilly-catastrophic event-based access to at least one life-sustaining or civil security resource. That resource is then maintained pending a need to permit subscription-based access to the resource in the event of a catastrophic event. Authorized beneficiaries are then provided with consideration-based access to this plurality of private civil security resources.

The private civil security provisions can comprise various life-sustaining resources as pertain to various categories of life's necessities, including, for example, breathable air, water, food, and protective clothing. Deployable shelters can also be included if desired. By one approach, non-civil security resources (such as, but not limited to, luxury items) can also be provided if desired to supplement such staples.

The nature of the subscribed-to resource can vary with the needs or requirements of a given application setting but may comprise one or more of a consumable necessity of human life, a non-consumable necessity of human life, shelter, transportation to effect the above-mentioned access, and/or rescue, to note but a few useful examples.

The civil security facilities can comprise various facilities as have application with respect to protecting such authorized beneficiaries from the effects (including the aftermath, if any) of a civilly-catastrophic event and other dangerous or unpleasant environmental or external influences and forces. The facilities can include, for example, such things as civil security shelters (including both short term and longer term facilities), transportation rally points, trans-shipment facilities and/or distribution facilities for civil security provisions, medical services facilities, training facilities, and so forth.

The civil security services can similarly comprise any of a wide variety of services as have application with respect to protecting such authorized beneficiaries. Exemplary services include, but are not limited to, civil security information services (including information that is both generally and specifically appropriate for individual ones of the authorized beneficiaries), transportations services, rescue services, and so forth.

So configured, authorized beneficiaries will have concrete, predictable access to various categories of privately supplied civil security resources. These steps are readily facilitated without dependency upon (and perhaps even in spite of) governmental oversight, participation, or control. The particular resources provided can vary with the needs and requirements of the authorized beneficiaries. Importantly, via these teachings individuals can benefit from a greatly increased opportunity to bring a considerably improved measure of security into their lives, knowing that, should a civilly-catastrophic event indeed be visited upon them, they will have extraordinary and reliable access to privately facilitated civil security resources.

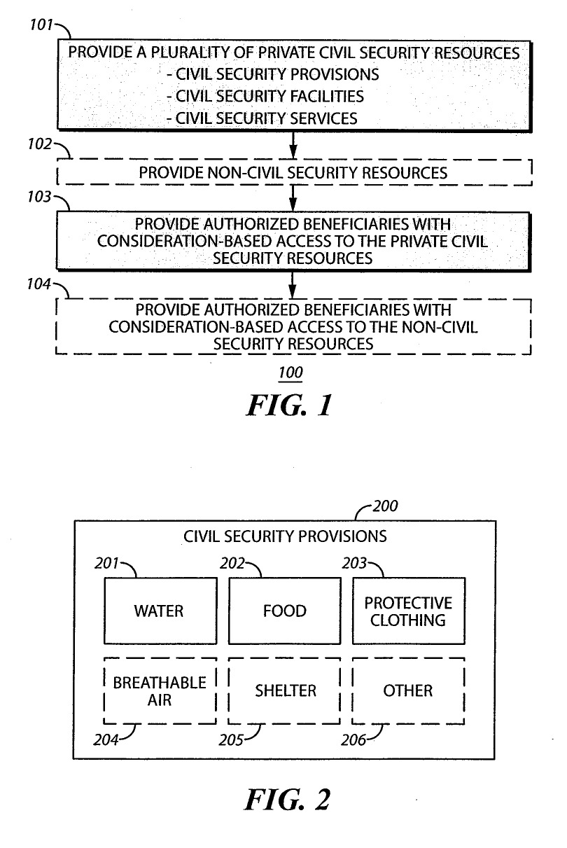

These and other benefits may become clearer upon making a thorough review and study of the following detailed description. Referring now to the drawings, and in particular to FIG. 1, a corresponding process 100 provides a plurality of private civil security resources. As used herein, “private” will be understood to refer to the opposite of public ownership or control (as exemplified by governmental or ecclesiastical ownership or control) but can include such things as ownership or control via publicly traded ownership (via, for example, publicly traded stock or the like), ownership or control via a not-for-profit entity, or the like.

The plurality of private civil security resources can vary to some degree with respect to category and kind of resource. By one approach, however, such resources will comprise, at least in part, civil security provisions, civil security facilities, and civil security services. Generally speaking, both the civil security provisions and civil security facilities are physical components rather than virtual components or products of the intellect. For example, the civil security provisions will typically comprise physical support and/or protection of one kind of another. Similarly, the civil security facilities will also typically comprise physical assets such as, but not limited to, physical shelters that provide real, substantive physical protection from physical threats to human life. Additional details in this regard are provided below. Also as described in more detail below, however, the civil security services can comprise either physical real world services or virtual-content services.

These civil security provisions can comprise, for example, a plurality of life-sustaining resources as pertain to a plurality of differing categories of life's necessities. Referring momentarily to FIG. 2, examples in this regard include, but are not limited to, such elemental staples as water 201 (which can comprise water in a pure or impure state and/or other water-based palatable fluids), food 202 (which can comprise a wide variety of raw to highly processed food, nutritional supplements, and so forth, and protective clothing 203 (where “protective” will be understood to refer to protection against one or more potentially hazardous environmental influences such as temperature extremes, precipitation, high velocity winds, and the like but not to matters of fashion, social comment, or the like).

These civil security provisions 200 can further optionally include such components as breathable air 204 (which may comprise, for example, a fresh air supply, an oxygen supply (including but not limited to oxygen generators such as, but not limited to, chemical oxygen generators that often produce oxygen as part of a corresponding exothermic reaction) that can serve as a source of oxygen to mix with other atmospheric components, and/or personal or area air filters that serve to remove harmful airborne contaminants from the air prior to being inhaled by an authorized beneficiary), deployable shelters 205 (where “deployable” will be understood as referring to portable shelters such as tents, canopies, inflatable structures, and the like), and other items 206 as may be appropriate to meet the needs of a given application setting.

By one approach, these civil security provisions can be so provided in an aggregated form. Such might be the case, for example, when accumulating such material at a warehouse or the like. These teachings will also accommodate, however, forming such civil security provisions into corresponding units of civil security provisions. To illustrate, one such unit of civil security provisions as intended, for example, for a single authorized beneficiary might comprise, at least in part, consumable fluids, foods, medical supplies, personal hygiene supplies, and environmental threat abatement supplies (such as, for example, breathing masks, hazardous materials handling garb, and the like).

Such a unit of civil security provisions might comprise, for example, a short term unit that comprises a quantity and variety of civil security supplies that are adequate to sustain life for that one authorized beneficiary for, say, at least about thirty days but no more than, say, about one year.

Those skilled in the art will recognize and understand that there are various ways by which such adequacy can be determined, measured, and/or established. For example, by one approach, the adequacy of any food contents can be determined as a function of a particular target caloric intake per person on a per day basis. Similarly, the adequacy of any consumable fluid contents could be determined as a function of a particular target quantity intake per person on a per day basis.

The particular time frames suggested in the above examples are intended only to serve an illustrative purpose and are not to be construed as limitations with respect to the practice of these teachings. Those skilled in the art will also appreciate and understand that such a unit of civil security provisions can comprise a quantity of supplies that are intended to support more than one authorized beneficiary for the given period(s) of time. For example, such a unit might comprise a family unit that contains sufficient contents to adequately sustain life for a family of four authorized beneficiaries.

These teachings will also accommodate providing civil security provisions that differ from one another in ways other than by category or kind. For example, both branded and generic versions (or other differentiators with respect to quality) of a same kind of item can be selectively provided if desired. Some particular examples in this regard now follow (it being understood that these examples are provided for illustrative purposes and are not intended to comprise an exhaustive listing of such possibilities).

These teachings will also accommodate the use of furniture pieces and/or an entire furnishing system that can also serve to store a supply of civil security provisions (such as food or other emergency supplies) that can be quickly accessed in time of an emergency. The supply might be sufficient, for example, to contain a 3 day, 7 day, and/or 10 day supply of civil security supplies (or other suitable quantity from one hour to 1000 days) for a given number of beneficiaries. Such an approach can be of great benefit to beneficiaries who may otherwise lack sufficient storage space for both their furniture and the like as well as such a store of supplies.

As one illustrative example in this regard, the idea of a “Murphy Bed” type of racking system that can be folded into a wall and still be functional as a sleeping unit can be employed in this manner. As another example, a couch can be configured with interior storage space that is accessible upon lifting up it's seat and/or backing cushions. Locking capabilities can be provided as desired.

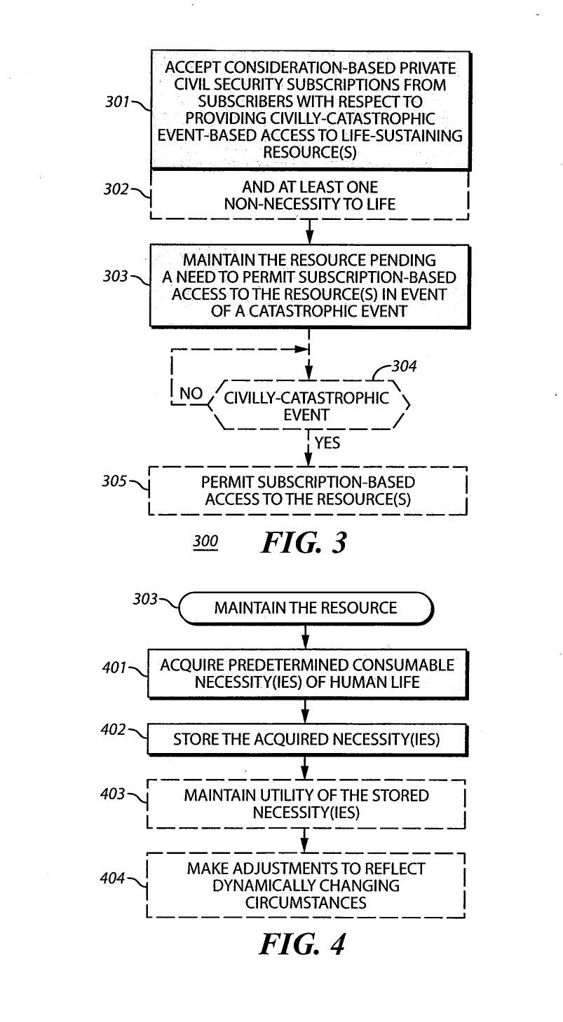

In one illustrative example, and referring now to FIG. 3, these teachings provide generally for accepting 301 consideration-based private civil security subscriptions from subscribers with respect to providing civilly-catastrophic event-based access to at least one life-sustaining resource or civil security resource (or, if desired, to a plurality of different kinds and/or categories of life-sustaining resources) such as, but not limited to, resources pertaining to hydration, nourishment, shelter, environmentally borne threat abatement (such as protection from chemical, biological, and/or radioactive threats and the like), transportation, and/or rescue services. This life-sustaining resource (or resources) can comprise, for example, a consumable necessity of human life (i.e., a necessity such as nourishment that tends to be reduced in supply as it is consumed) and/or a non-consumable necessity of human life (i.e., a necessity such as shelter that is not necessarily reduced in supply as it is applied or used).

This right of access can pertain, if desired, to a predetermined quantity of the life-sustaining resource. For example, a given subscription can relate to providing access to a one year's supply of the at least one life-sustaining resource for a given individual, number of individuals, or the like.

By one approach, these subscriptions may be accepted by, for example, a for-profit business. By another approach a not-for-profit business (such as a membership-based entity) may be the appropriate entity to offer and accept such subscriptions. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extends past the death of a named subscription beneficiary and further allows for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a one-time right of access or a perpetual right of access that may be retained, transferred, inherited, or the like);

ownership-based rights of access (as may occur when the subscription provides for ownership rights with respect to the civil security resources, when the subscription is based upon shareholder-based ownership of the provider of such civil security resources, or the like);

non-transferable rights of access (as may occur when the subscription, by its terms and conditions, prohibits transfer of the right of access to the civil security resources from a first named beneficiary to another);

transferable rights of access (as may occur when the subscription, by its terms and conditions, permits conditional or unconditional transfer of the right of access to the at least one life-sustaining resource from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided interest by and between multiple subscription beneficiaries with respect to a right to access the civil security resources);

non-ownership-based rights of access (as may occur when the subscription, by its terms and conditions, establishes the aforementioned right of access via, for example, a lease, a rental, or borrowing construct);

option-based rights of access (as may occur when the subscription, by its terms and conditions, establishes a right for an authorized beneficiary to later obtain access to some or all such civil security resources upon, for example, paying an additional supplemental amount at that time); and/or

credit-based rights of access (as may occur when a given individual predicates their right to access the civil security resources upon a representation, promise, or other credit-based transaction).

If desired, a plurality of differentiated subscription opportunities can be offered in this regard. This plurality of differentiated subscription opportunities can correspond, for example, to providing access to differing selections and/or quantities of the civil security resources or life-sustaining resource supplies. As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for accessing life-sustaining resources that, though nutritionally viable, are economically selected while another subscription might provide for life-sustaining resources that are more costly and in turn reflect, for example, a wider variety of choices within a given category of resource.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist. For example, a bearer certificate (or its legal or functional equivalent, such as a gift card) could serve to identify any individual who produces and bears that certificate as an authorized beneficiary.

By one approach, such access can be provided at the whim and convenience of the authorized beneficiaries. If desired, however, such access can be further conditioned in appropriate ways. For example, for many purposes and certainly as pertains to many of the civil security resources it may be appropriate to ordinarily limit such access to situations where such access is triggered, at least in part, by a civilly-catastrophic event having occurred or being likely imminent. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice (such as a particular level or degree of harm, interference, or negative impact upon a given minimum number of people). In addition, or in lieu thereof, such access may be predicated, if desired, upon a requirement of a particular level of objectivity or subjectively ascertained likelihood that a particular category or kind of civilly-catastrophic event will occur within a particular period of time.

As used herein, “civilly-catastrophic event” will be understood to refer to an event that substantially and materially disrupts a society's local, regional, and/or national infrastructure and ability to provide in ordinary course for the at least one life-sustaining resource. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation (or worsening) of that interruption.

A civilly-catastrophic event can be occasioned by any of a wide variety of natural and/or non-naturally-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based events (such as collisions with comets, large asteroids, and so forth, extreme solar flares, and the like), extreme environmental events (such as widespread uncontrolled fire or the like), and global or regional pandemics, to note but a few.

Examples of non-naturally-caused disasters capable of initiating a civilly-catastrophic event include both unintended events as well as intentional acts of aggression such as war, terrorism, madness or the like. Examples of non-naturally-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, exposure to harmful mutagenic influence, and so forth.

In addition, or in lieu thereof, such access can be further conditioned upon other criteria of interest or concern in a given application setting. Such conditional access can be absolute (as when a given individual may be granted or denied any access to any of the civil security resources) or may be relative (as when a given individual is granted or denied access to certain of the civil security resources while being allowed access to certain other of the civil security resources). As a simple illustrative example in this regard, a given individual may habitually and consistently exhibit highly anti-social behaviors; in such a case, the provider of such civil security resources may be willing to provide such a person with civil security provisions but may be reluctant to permit this person to have access to a long term shelter where a certain amount of social buoyancy and ability to compromise with others may be important to the long term ability of that facility to successfully protect its inhabitants.

A very wide variety of criteria can be potentially considered for such purposes. A few illustrative examples would include, but are not limited to, an authorized beneficiary's qualifications (based upon their experiences, aptitude testing, physical condition and capabilities, or the like), measured intelligence (based upon, for example, a traditional intelligence quotient (IQ test or the like), psychological test results, behavioral rest results, behavioral test results, race, nationality citizenship, ancestry, sexual orientation, gender, age, health, political beliefs and/or agenda, educational background, professional title, financial backing, athletic ability, mechanical ability, skills, and/or relationship to a third party entity with whom reciprocal relations regarding the provisions/facilities/services mutually agree to extend civilly-catastrophic event-based reciprocal access to one another's authorized beneficiaries).

As suggested previously, in addition to accepting 301 a subscription with respect to providing civilly-catastrophic event-based access to one or more consumable or non-consumable life-sustaining or civil security resources, a given subscription may also provide for similar access to at least one non-civil security resource or non-necessity 302 (that is, an item or service that is not, strictly speaking, necessary to sustain human life on an elemental basis). In such a case, this process 300 will then also maintain 303 the additional resource and permit access 305 to these non-civil security resources as well. An illustrative listing of representative non-necessities or non-civil security resources comprises, but is certainly not limited to:
a luxury consumable (such as, for example, alcoholic beverages, foods that provide an experience beyond simple survival, and so forth);
   a luxury non-consumable;
   clothing;
   a food preparation tool;
   a personal communication device;
   a personal hygiene item;
   non-human nourishment (such as dog food, cat food, and so forth);
   barter medium (such as bulk or coined precious metals including but not limited to gold, silver, and so forth);
   an electrical energy source (including but not limited to alternating current power sources, direct current power sources, fuel-consumptive power sources, renewable fuel source power sources, and so forth);
   an entertainment apparatus (such as game stations, musical instruments, reading material, and so forth);
   an educational tool (including but not limited to instructional texts, reference works, laboratory and demonstrative equipment, and so forth);
   physical conditioning, exercise, and maintenance training and equipment;
   repair and maintenance tools and services;
   crafts supplies and training; and/or
   sports equipment and facilities;
      to note but a few examples.

This process 300 then provides for maintaining 303 the resource(s) pending a need to permit subscription-based access to the resource(s) in response to the occurrence of a catastrophic event. This, of course, can comprise maintaining the resource on behalf of the subscriber and/or on behalf of another authorized beneficiary. The specifics of such maintenance will of course vary with respect to the nature of the resource or resources being maintained.

As one example, and referring momentarily to FIG. 4, when the resource (or resources) comprise one or more predetermined consumable necessities of human life, maintaining 303 the resource can comprise acquiring 401 the at least one predetermined consumable necessity of human life to thereby provide acquired necessities and then storing 402 those acquired necessities to thereby provide stored necessities that are held on behalf of the corresponding authorized beneficiaries pending a need to access those stored necessities in the event of a triggering civilly-catastrophic event. These acquisition and storing steps can further comprise, if desired, acquiring and storing non-consumable necessities of human life and/or consumable or non-consumable non-necessities of human life.

Acquisition 401 of such items can be achieved through any of a variety of means. By one approach the items may be procured on the open market. By another approach the items may be purchased or otherwise acquired from third parties via private negotiations. By yet another approach the entity that provides and accepts these subscriptions may itself create (through manufacturing, farming, or the like) the items of interest. In some cases the acquired item may comprise a staple of ordinary commerce. In other cases the acquired item may be unique and/or proprietary to the acquiring/storing entity.

Referring again to FIG. 1, the civil security facilities will typically comprise physical assets that tend, categorically, to comprise part of a private civil security infrastructure. Such civil security facilities will typically comprise physical assets that tend, categorically, to comprise part of a private civil security infrastructure. Such civil security facilities can, therefore comprise, for example:

one or more civil security shelters;

one or more rally points (at which authorized beneficiaries can gather in response to a civilly-catastrophic event in order to receive certain civil security services such as transportation to another civil security facility such as a shelter or at least to a location that is away from a location that presently (or imminently) lacks civil security (due, for example, to a civilly-catastrophic event, its aftermath, or both));

a location where at least some of the authorized beneficiary's civil security provisions are available (such as a metropolitan, local, regional, and/or national distribution facility);

a trans-shipment facility for at least some of the civil security provisions (where, for example, dis-aggregate provisions are brought and then parsed and aggregated into corresponding units of provisions destined for particular recipient authorized beneficiaries);

a medical services facility;

and so forth, to note but a few relevant examples in this regard.

The teachings will readily accommodate a wide variety of civil security shelters. For example, this process 100 can provide for both temporary civil security shelters and longer term civil security shelters. A temporary civil security shelter will be understood to comprise a shelter that is configured and arranged to adequately shelter and sustain human life for a relatively short period of time. For example, such a temporary shelter might prove sufficient in this regard for, say, no more than about ten inhabitants for no more than about one week, ten days, 15 days, and the like. Generally speaking, a temporary shelter such as this is designed and intended to only serve as a temporary refuge from the effects of a civilly-catastrophic event. Should longer term accommodations be necessary in a given instance, the inhabitants of such a temporary shelter will often be better served to move to a longer term civil security shelter.

A long term civil security shelter will be understood to comprise a shelter that is configured and arranged to adequately shelter and sustain human life for a relatively longer period of time. For example, such a temporary shelter might prove sufficient in this regard for, say, no more than about 100 inhabitants for up to about three months, six months, one years, or the like. (Again, such numeric examples serve an illustrative, rather than limiting, purpose only.)

These teaching will also readily accommodate the provision of a longer term civil security shelter up to and including an indeterminate term civil security shelter that is configured and arranged to adequately shelter and sustain human life for an indeterminately long period of time. A shelter of this type will typically be characterized not only by an ability to protect its inhabitants against the rigors of the local environment and to contain a relatively large and varied supply of provisions, but by an ability to exist and operate in a fully or at least substantially independent manner. This can relate in particular to an ability to create and/or otherwise replace its consumable provisions (by, for example, growing food, creating power, and so forth).

It is also possible for such shelters to differ from one other in other ways. For example, such shelters may differ with respect to the non-survival related amenities that are provided. These differences can relate to categories of amenities (such as educational facilities, workshop facilities, food preparation facilities, communication facilities, entertainment and/or recreation facilities, or the like) and/or to a relative level of perception of quality, comfort, convenience, or the like.

The aforementioned civil security services can comprise any of a relatively wide variety of offerings. Some examples include, but are certainly not limited to:

transportation services (where such transportation services are not ordinary mass or individual transit services but instead represent, for example, services that are designed, scheduled, and deployed to effect transportation of dispossessed persons away from a location that substantially lacks civil security (such as an area afflicted by a civilly-catastrophic event);

civil security information (including both civil security information that is generally appropriate for a large number (or all) of the authorized beneficiaries (such as civil security preparedness training or the like) as well as information that is specifically appropriate for individual ones of the authorized beneficiaries (such as personal contingency instructions that are formed and provided to guide specific authorized beneficiaries during a time of need regarding particular actions and behaviors that such specific individuals should take and observe when responding to a civilly-catastrophic event as well as consulting services that assist such individuals with respect to fortifying their relative positions and/or otherwise better protecting themselves against the effects of various civilly-catastrophic events);

communications services, including long distance communication services (including, for example, wireless-based services) that are configured and arranged to provide substantially persistent communication services notwithstanding interaction of the long distance communication service with the effects of a civilly-catastrophic event (which may include, for example, satellite-based communications, quickly deployed wireless base stations (that comprise, for example, mobile terrestrial platforms, aerial platforms and so forth), and the like);

civil security rescue services to facilitate, for example, retrieving selected authorized beneficiaries from dangerous circumstances that are owing, at least in part, to a substantial lack of civil security (including, for example, immediate threats posed by life-threatening influences such as fire, collapsed buildings, lawless unpoliced individuals, and the like as well as less-immediate threats (such as starvation, dehydration, infection, or the like) that can follow a substantial failure of civil infrastructure;

civil security delivery services to provide for deliveries to authorized beneficiaries or the like of such things as their corresponding civil security provisions, fuel, and so forth;

civil security medical services (including but not limited to both fixed location and mobile services);

civil security physical security services (to provide, for example, physical security (such as guards, fences, and other barriers, surveillance equipment, and so forth) for residences, businesses, and other physical property of interest to an authorized beneficiaries);

independent utilities facilities installation services (to provide, for example, for the installation of fuel-burning generators, renewable energy-based power generators, propane-based heating plants, and so forth at, for example, the residences and businesses of authorized beneficiaries); and/or

post-civilly-catastrophic event social relationship facilitation services (to facilitate rebuilding social networks, friendships, partnerships, and romantic relationships for the survivors of civilly-catastrophic events);

and so forth, to note but a few relevant examples.

In the event of a civilly-catastrophic event, ordinary transportation may be difficult and/or impossible for certain individuals. This may be due to congested roadways, impaired transportation infrastructure, civil disorder, confusion and/or uncertainty regarding a best direction in which to proceed, as well as problems that certain would-be drivers and/or passengers may themselves face, to note but a few illustrative examples in this regard. A private entity can arrange appropriate transport facilities that will travel a specific route during such a time of need to pick up authorized beneficiaries of such a service. By one approach this activity will only occur in the event of a sufficiently serious civilly-catastrophic event and will not comprise an ordinary service during less trying times. The vehicles used for this purpose can comprise, for example, a bus, van, or similar terrestrial platform. Other vehicles, such as helicopters, hovercraft, boats, and so forth may also be employed where appropriate. In addition, some vehicles may operate to provide both transportation and shelter. The right of a given individual to gain passage on such a vehicle can be arranged in advance of such a civilly-catastrophic event and/or at a specific time of need.

These teachings will also accommodate the use of a floating sled or similar structure that protects private civil security beneficiaries in a rescue or evacuation scenario when weather or environmental conditions are not ideal. This could also be used for injured individuals. Such a privatized civil security personnel mobile storage unit could be hardened so that it can protect against one or more nuclear/biological/chemical events and could even have a small store of self contained civil security provisions. By one approach this could include use of a structure that is shaped like an egg to facilitate towing the unit in water or to put on a set of wheels and pull the unit across land.

These teachings will accommodate having an authorized beneficiary arrange for rescue services to be rendered in the event of a civilly-catastrophic event. This could comprise, for example, rescue personnel quickly locating the authorized beneficiary and physically accessing that authorized beneficiary to effect their removal to another location. If desired, such a service can be supplemented to include allowing such an authorized beneficiary to identify another party to be rescued and/or to be located and accompanied as a precautionary or protective measure.

If desired, authorized beneficiaries of a subscription-based private civil defense program can participate in the program by providing threat assessment information to, for example, a central information collection function. This can include, for example, such individuals making regular reports (via telephone, email, a website, a wireless communications device, and so forth) regarding their observations in this regard. By another approach, in combination or in lieu thereof, one or more threat-detection sensors can be deployed at the individual's property (for example, their homes, businesses, vehicles, their clothing, and so forth). Such sensors can be, if desired, coupled to a communication network of choice that forwards the gathered information (using a real time, near real time, or batch protocol of choice) to the central information collection function. If desired, such activities can be supplemented with training for the participating individuals regarding how these observations and so forth are to be carried out.

Facilitating one or more of the aforementioned services can occur in conjunction with a specialized or otherwise dedicated button (or other user interface of choice) on a telephone, personal digital assistant, or other hand-held or wearable communications device that signals the need for an immediate private civil defense response. This one button, then, can serve to prompt and yield an immediate response. For example, such an approach might be used in a partnership or other collaborative arrangement with a company such as Apple Computer to use their iPhone-like technology in conjunction with the addition of a privatized civil security button to thereby enhance their telephony offerings. As stated by Apple, the “iPhone combines three amazing products—a revolutionary mobile phone, a widescreen iPod with touch controls, and a breakthrough Internet communications device with desktop-class email, web browsing, maps, and searching—into one small and lightweight handheld device. iPhone also introduces an entirely new user interface based on a large multi-touch display and pioneering new software, letting you control everything with just your fingers. So it ushers in an era of software power and sophistication never before seen in a mobile device, completely redefining what you can do on a mobile phone.” By this approach, then, a fourth revolutionary concept can comprise configuring and arranging the iPhone to have the ability to help save the user's life in the event of a civilly catastrophic event or other disaster. Pushing such a button, for example, can serve to walk the user through one or more best practices to survive a given emergency situation.

These teachings will further accommodate, as desired, a computer program, preferably browser-based, to permit a privatized civil security beneficiary to input their zip code (or other postal code or the like) along with the number of people to be treated as beneficiaries and the square footage of their house or other building or facility of interest. With this input, the program can then provide a PCSR (Privatized Civil Security Ranking) that will list the probability and severity of a civilly-catastrophic event happening in that area within some given period of time. By one approach, this program can take into account other factors such as local population (density, characteristic representative demographics, or the like), climate and/or weather, geological studies and history, local businesses, industry, or utilities, and historical data of varying kinds. This program can then rank and specify the civil security provisions that are advisable and/or likely to be needed for the specified number of beneficiaries over various durations of time. This system might be tied to a manufacturing and/or member services network that will then create the proper supplies and wait for a consultant to help with storage, training, and/or corresponding implementation or training. Such an approach can account for the fact that different parts of the globe have different corresponding likely threats and allow for maximum amounts of the appropriate provisions to be at one's home. This program can also be used for travelers who wish to rent or otherwise take their own civil security provisions on a business trip, vacation, or extended stay. Such a program can use some or all of the same factors to rank the risk and/or relative preparedness of the hotel or area where such a beneficiary might be staying. By one approach, such a system could be contracted with hotels to provide preparedness rankings so that beneficiaries and potential beneficiaries can enjoy an increased likelihood of survival and/or comfort in the event of a civilly-catastrophic event.

These teachings will further accommodate use of a check-in check-out procedure at airports or other ports of call where if a person is a member of a privatized civil security network they can check-in their civil security provisions (including corresponding personal communications devices, threat detectors, emergency supplies, and so forth) when they check into the airport and they can pick up identical or corresponding gear when they arrive at their destination. By one approach this could comprise using privatized civil security kiosks at various airports, train stations, bus terminals, boat docks, and so forth to permit such an exchange of personal protection gear.

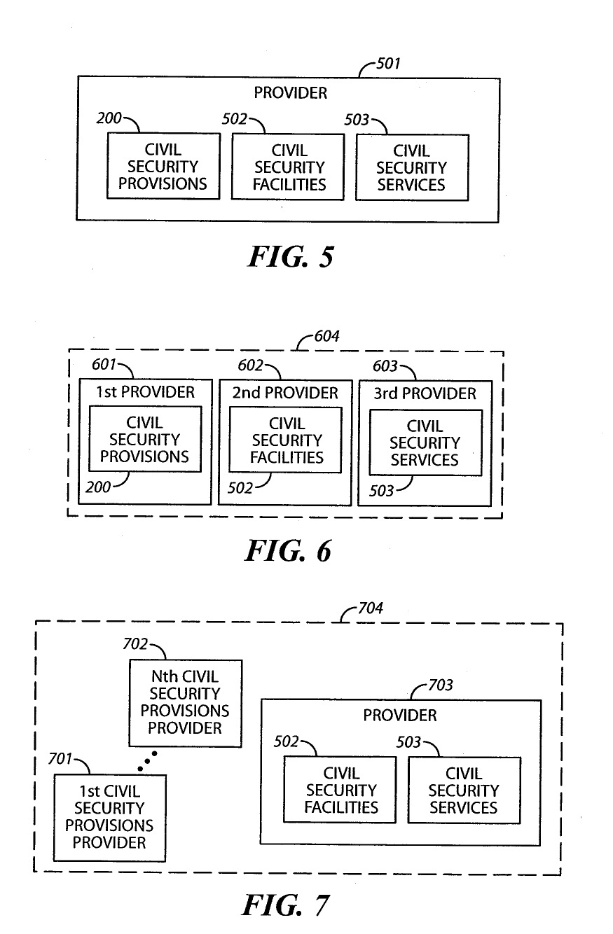

By one approach, and referring momentarily to FIG. 5, this process will readily accommodate providing such civil security provisions 200, civil security facilities 502, and civil security services 503 by a single provider 501. Such a provider 501 can be integrally involved with designing, providing, maintaining, and offering such civil security resources or can comprise an aggregator of such resources, in whole or in part, as are provided by other sources.

As noted these teaching can be flexibly applied in various ways in this regard. For example, and referring momentarily to FIG. 6, the civil security provisions 200 can be provided by a first provider 601, the civil security facilities 502 can be provided by a second provider 602, and the civil security services 503 can be provided by a third provider 603 wherein the first, second, and third providers comprise separate entities (as when, for example, these providers comprise separate legal entities having no co-ownership or common points of control). In such a case, these separate providers can meet the needs of this step by acting in an aggregated manner 604 (directly or indirectly) with one another.

Yet other arrangements are possible. For example, and referring momentarily to FIG. 7, a single provider 703 can provide the civil security facilities 502 and the civil security services 503 while the civil security provisions are provided by a plurality of civil security provisions providers represented here by a first civil security provisions provider 701 through an Nth civil security provisions provider 702 (where “N” will be understood to comprise an integer greater than one). Persons skilled in these arts will understand and appreciate that numerous permutations and combinations of these elements as well as other possibilities are available. Such alternatives are well within the scope of these teachings and are rightly considered to comprise a part of this invention.

A private civil security provider will encounter particular difficulties not faced by providers of other, more traditional, products and services. For example, marketing such services, provisions, and facilities to consumers or clients may prove challenging because individuals may be hesitant to participate because of their reluctance to acknowledge the presence of certain threats or perhaps because they mistakenly believe that their federal, state, local, provincial, or municipal government is effectively addressing and preparing for such civilly-catastrophic events. Further, the business of civil security presents several unique obstacles and challenges to a business plan or model because the business partly operates within a realm sometimes occupied (or is at least perceived as being occupied) by various governmental entities. Some particular examples to address these concerns now follow (it being understood that these examples are provided for illustrative purposes and are not intended to comprise an exhaustive listing of such possibilities).

Referring again to FIG. 1, this process 100 will also optionally provide for the provision 102 of non-civil security resources. Such non-civil security resources comprise supplies and items that are not, strictly speaking, necessary to ensure human survival and hence may be viewed as luxuries. Such items can quite literally span the full gamut of available offerings and can include both unique items (such as original works of art) and more commonly available offerings (such as jewelry, pleasure reading materials, audio playback devices, and so forth). Again, differentiation can exist with respect to actual or perceived levels of quality as pertain to such items if desired.

These steps of providing such civil security resources can further comprise maintaining such resources. This can comprise, for example, maintaining the freshness and usability of civil security provisions (by replacing outdated or soon-to-be outdated supplies), replacing an existing resource with a better substitute that becomes available, maintaining present and/or imminent usability of a civil security shelter or transport vehicle, updating civil security-related information to reflect current data and intelligence, vetting and re-vetting personnel, and so forth. Such maintenance can be provided, in whole or in part, by the provider of such civil security resources or can be outsourced if desired.

This process 100 then provides for providing 103 authorized beneficiaries with consideration-based access to the plurality of private civil security resources. There are various ways by which such authorized beneficiaries can be identified. For example, by one approach, such authorized beneficiaries can attain this status as per the terms and conditions of a consideration-based private civil security benefits subscription as mentioned above with respect to FIG. 3. For example, a given subscription can provide such status for a stipulated one-year period of time for one or more authorized beneficiaries as correspond to that subscription.

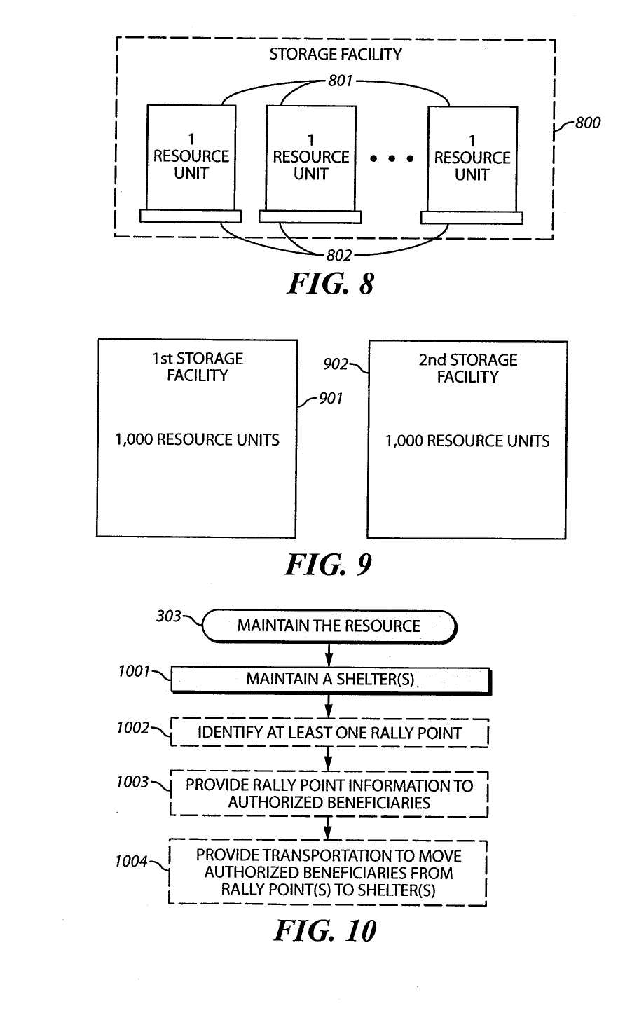

Returning to the security subscriptions discussed with respect to FIGS. 3 and 4, the maintenance of the resource 203 may include storing the acquired necessities 402. By one approach such storage 402 occurs through use of one or more storage facilities 800, illustrated in FIG. 8, which are owned or controlled by the subscription accepting entity. Any suitable storage facility may be used for this purpose with examples comprising (but not being limited to) above ground man-made shelters, below ground or below water facilities (including purposefully excavated facilities, natural caverns, and so forth), and water borne facilities (such as barges and the like). Each such storage facility 800 will likely serve to store the resources as correspond to a plurality of authorized beneficiaries. By one approach such resources are stored in the aggregate. By another approach, or in combination with an aggregated approach, some or all of the acquired necessities are stored in subscriber-based bundles 801. For example, each such bundle 801 can comprise a one year supply of all acquired items for a single adult authorized beneficiary. As another example, such a bundle 301 could comprise a one year supply of all acquired items as are intended for a family of four authorized beneficiaries.

Other possibilities of course exist. For example, a single authorized beneficiary may have a first bundle comprised of staple items that are acquired and stored for all beneficiaries and a second bundle comprised of custom items that are specifically and uniquely acquired for this particular beneficiary or class of beneficiaries (such as beneficiaries who all share a common dietary ailment or condition, sensitivity, medical condition, preference, or the like).

The bundle 801 itself can be realized via any of a wide variety of encapsulating or restraining mechanisms. For example, a tarp and tie-downs can be used to segregate the goods and form the described bundle. As another example, discrete storage cabinets formed of wood, metal, plastic, canvas, or other material of choice could be employed for this purpose. Shrink wrap materials could also be employed in this regard. In addition, if desired, these bundles 801 can be individually palletized (i.e., each placed upon and optionally secured to a pallet 802). Palletization, in turn, will permit ready and efficient movement of such bundles 801 to, about, or from a given storage facility 800 and/or delivery of such a bundle to an authorized beneficiary when such delivery comprises the desired form of granting access to such resources.

The use of such bundles (and particularly the bundling of staple items in a manner calculated to provide at least a minimum level of survival support to a predetermined number of authorized beneficiaries for at least a predetermined period of time) provides highly leveragable resource allocation opportunities as well. For example, and referring now momentarily to FIG. 9, a first storage facility 901 may contain 1,000 such storage units while a second storage facility 902 may contain an additional 1,000 such storage units. By treating such storage units, at least in part, as being fungible with one another, such resources can be made available to authorized beneficiaries in time of need by accessing a storage facility that is positioned to provide the earliest relief to the beneficiaries rather than by necessarily requiring all beneficiaries to only access their resources from a specific pre-ordained facility.

Referring again to FIG. 4, maintaining 303 the resource in such a context can further optionally comprise maintaining 403 the utility of the stored necessities. This can comprise, for example, monitoring the usability of perishable items and replacing such items on a corresponding schedule. As another simple illustration this step 403 can comprise holding certain items in deep refrigeration or in other special storage conditions as may suit the proper maintenance of such items.

Such maintenance 303 can also optionally comprise making adjustments 404 to the stored necessities to reflect dynamically changing circumstances as occur during the consideration-based private civil security subscription period. As one illustration, a new product may become available that is particularly useful in treating a particular infectious condition that may likely arise upon the occurrence of a particular kind of civilly-catastrophic event. In such a case, maintaining 303 such resources can readily accommodate updating the acquired and stored items to include a supply of this new product. Accordingly, this step of making adjustments 404 can readily comprise one or more of removing a particular one of the stored necessities (as when a better substitute becomes available, when the stored necessity itself is shown to be less effective for its intended purpose than was originally thought, and so forth), adding additional ones of the stored necessities (as when it becomes subsequently understood that more of a particular item is desirable to achieve a particular survival-related goal or purpose), adding at least one new stored necessity that is not already stored (as illustrated in the example provided above), and so forth.

In the examples provided above, the resource being acquired and maintained comprises consumable or non-consumable items. As noted earlier, however, these teachings are applicable for use with other resources as well. For example, and referring now to FIG. 10, maintaining 303 the resource may relate to providing civilly-catastrophic event-based access to a shelter. By this approach this step of maintaining 303 the resource can comprise maintaining 1001 such a shelter.

Much is known in the art regarding construction and maintenance of shelters. Such a construction will usually at least serve to protect the inhabitants from environmental stress and extremes. In addition to walls and a roof such a shelter will typically also comprise internal temperature control, lighting, storage facilities, sleeping facilities, food preparation facilities, personal hygiene facilities, and so forth. For present purposes such a shelter may also be equipped to provide for water treatment (such as filtering, bacteria removal, and so forth), waste treatment and/or recycling, electrical power generation, and/or air treatment (including but not limited to conditioning, filtering, and so forth). By one approach such a shelter can also be equipped with communication facilities including a variety of wireless broadcast capabilities, long-distance two-way communications capabilities, and so forth.

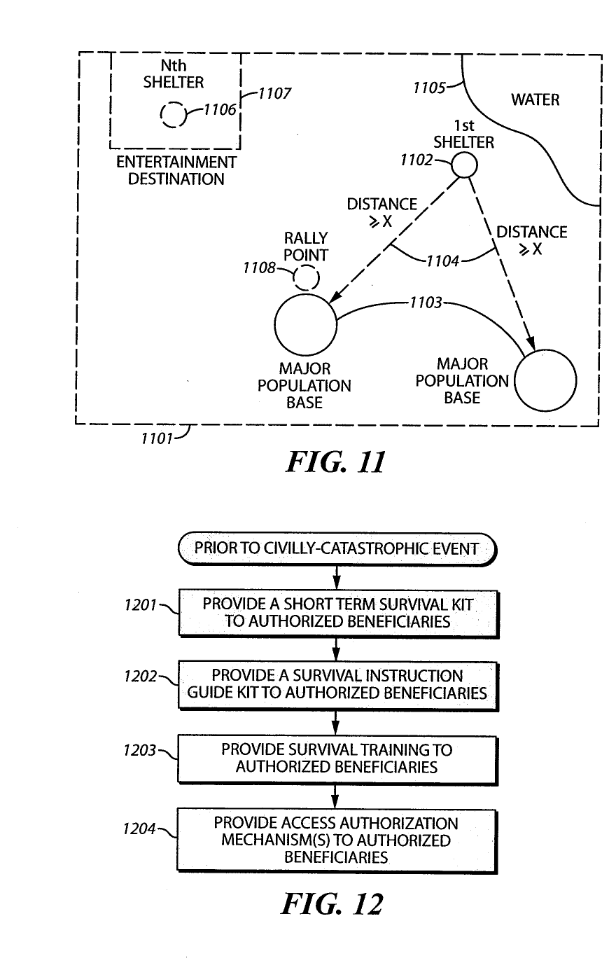

Security will likely comprise a primary concern for such a shelter. In particular it will likely be important to secure the shelter, any resources as are stored or otherwise available at the shelter, and the inhabitants of the shelter from unauthorized entry and access. By one approach, this can comprise maintaining the shelter in a location that is substantially distal from a nearest substantial human population. For example, and referring momentarily to FIG. 11, within a given geographic region 1101 (such as a continent, country, or the like) a shelter 1102 may be separated from the closest major population bases 1103 by a distance that at least exceeds some predetermined substantial distance X 1104. Depending upon other factors, this distance X might comprise, for example, 800 kilometers. Other factors might well play a part in this regard, of course. For example, a significant natural barrier (such as a large mountain range) might lie between a major population base and a shelter and make reasonable a shorter separation distance between such entities.

When possible, and with continued reference to FIG. 11, it may be desirable to locate such a shelter 1102 in relative proximity to a water source 1105. A suitable water source 1105 can comprise a ground-level water source or an underground water source as, in either case, ready access to the water source may be available. This, in turn, can be useful with respect to ensuring an adequate supply of water for the inhabitants of the shelter 1102 in times of need. A ground-level water source may also provide a means of ingress and egress to facilitate the comings and goings of the authorized beneficiaries (for example, a navigable waterway can provide an effective pathway by which to transport authorized beneficiaries to the shelter 1102).

Notwithstanding that it may be desirable to locate such shelters at a considerable distance from major population centers, this does not necessarily require that such shelters be secreted within completely primitive and/or wild settings. For example, one useful approach might be to locate such a shelter 1106 proximal to an entertainment destination 1107 (such as, but not limited to, remotely located golf courses, resorts, dude ranches, casinos, and so forth). In such a case at least some of the infrastructure that may be required and/or useful for the shelter can be shared with the facilities of the entertainment destination and thereby reduce the effective costs of installing and maintaining such facilities.

For a variety of reasons it may be appropriate to provide a plurality of such shelters in various locations throughout a relatively wide geographic region such as a continent or country. Such a dispersal can aid with reducing the logistic difficulties of transporting authorized beneficiaries to such a shelter during times of need. Dispersed shelters can also help ensure that at least some shelters will more likely survive civilly-catastrophic events that pose sufficient destructive force to destroy such a shelter or to otherwise significantly impair its purpose and functionality.

When providing a plurality of shelters, it may also be useful to differentiate such shelters from one another with respect to, for example, their features and/or accouterments. Such shelters may be differentiated, for example, with respect to their relative support for such things as a maximum supportable population, a depth and breadth of provided non-essential accouterments of life, medical facilities (such as, but not limited to, specialized equipment such as respirators, dialysis equipment, operating facilities, and so forth), pet animal accommodations, risk threat abatement capability, entertainment facilities, and so forth. Assignment and/or access to a given differentiated shelter can be determined, at least in part, by such things as relative initial proximity of the authorized beneficiary, the terms and conditions of the corresponding subscription agreement, and so forth.

By one approach these teachings can be simply practiced by provision of shelter and/or life-sustaining supplies; gaining physical access to such resources comprises the responsibility of the authorized beneficiaries. During such times, of course, it can be expected that civil conditions will be troubled and confusing. Therefore, by another approach these teachings can further encompass transporting at least some of the authorized beneficiaries to the shelter and/or supplies in response to the occurrence of a civilly-catastrophic event. There are various ways by which to accomplish such a task.

Referring again to FIG. 10, by one optional approach at least one rally point can be identified 1002. (An example of such a rally point appears in FIG. 11 as denoted by reference numeral 1108.) Such a rally point need not be reserved only for this purpose and may, for example, simply comprise a convenient location for at least some authorized beneficiaries. Example rally points might include sports stadiums and auditoriums, amusement parks, and the like. When possible, it may be helpful to locate such a rally point relatively near an airstrip and/or a navigable waterway. Such amenities, in turn, can potentially be used when transporting the gathered beneficiaries to their destination (as when, for example, a destination shelter is accessible from the navigable waterway that is also readily accessible from the rally point).

By one approach, one or more such rally points can be identified for each larger population area that contains authorized beneficiaries. It would also be possible, of course, to identify rally points to serve a similar function in more rural settings as well if desired.

This process can then optionally provide 1003 information regarding such rally points to the authorized beneficiaries. This information can be provided prior to the occurrence of a civilly-catastrophic event if desired. It may also be useful or possible to provide such information (either in the first instance or as a supplemental notice) following the initiation of such an event. The latter may be achieved using such communication means as may be available at the time. It would also be possible to provision each authorized beneficiary (or family or company of beneficiaries) with one or more communications devices by which such information could be provided. This process could then provide 504 appropriate transportation to move the authorized beneficiaries from these rally points to the destination (such as to a designated shelter).

In many instances such transportation can comprise standard vehicles (cars, buses, boats, airplanes, railroad cars, and so forth). If desired, however, more specialized equipment could be used including but not limited to armored transports, environmentally-contained vehicles or trailers, and so forth.

These teachings can readily accommodate other features as well. For example, and referring now to FIG. 12, prior to the occurrence of a civilly-catastrophic event an authorized beneficiary can be provided 1201 with a short-term survival kit to facilitate their survival prior to their being able to access the aforementioned stored necessities upon the occurrence of a civilly-catastrophic event. Such a short-term survival kit might comprise, for example, a seven day supply of nourishment, clothing, food preparation items, bedding, navigation tools, communication tools and/or location beacons, first aid supplies, water treatment items, items to aid with protecting against or otherwise treating environmentally borne hazards, maps, portable power sources, fire starting equipment, survival instructions, and so forth.

As another example, authorized beneficiaries could be provided 1202 with a survival instruction guide kit. These instructions could provide information regarding survival practices, emergency responses, and so forth. By one approach each authorized beneficiary who comprised a part of a shared group (such as a family group, a company group, and so forth) would receive such a kit. This, in turn, would facilitate unity of action, purpose, and result in the event of a civilly-catastrophic event. For example, by each knowing and observing the shared instructions provided by such an approach, the participants would be able to take their own coordinated actions while being relatively secure in their knowledge of what their group counterparts were also likely doing at that time.

This survival instruction guide kit could comprise, for example, a book or manual having printing survival instructions and information in combination with fill-in-the-blank opportunities whereby a given authorized beneficiary could customize the instructions to specifically suit their particular needs and situation. Such blanks could be used, for example, to prompt the beneficiary to think through and to record information such as their primary and secondary rally points or other family/group meeting points and protocols, communications protocols and contact information, specific items (perhaps somewhat unique to the individual and which may, or may not, relate to the survival of that individual) that should be stockpiled or otherwise made readily available in the event of a civilly-catastrophic event, and so forth. Such a book or manual could include indexes, tabs, or other navigation tools to permit a reader to quickly find the relevant information they require during a time of need.

These teachings would also accommodate providing 1203 survival training to authorized beneficiaries. Such training could comprise in-person, on-site training, live instructors, and/or previously prepared teaching resources such as, but not limited to, electronic learning resources. This training could include both general information regarding specific do's and don'ts as pertain to different kinds of civilly-catastrophic events as well as more specific information regarding specific actions that should be taken by the authorized beneficiary with respect to successfully achieving access to their subscribed-to resources as per their subscription.

These teachings will also accommodate providing 1204 authorized beneficiaries with a corresponding authorization mechanism by which they can effect their right of access to the resources provided by their subscription. This may comprise a mechanism that the beneficiary carries with them as personal property (such as an identification card) or, for example, a biometric-based identity authentication process that relies upon fingerprints, retinal patterns, or some other relatively unique aspect of the human body.

Returning once again to FIG. 1, the process 100, as mentioned, provides 104 the authorized beneficiaries with consideration-based access to the non-civil security resources. Notwithstanding the provision of such civil security resources, this step of providing access to such resources can readily comprise providing a plurality of different access opportunities. Such opportunities can differ from one another in any number of ways. For example, these opportunities can differ from one another with respect to the specific resources that are included, the quantity of resources that are included, the duration of time during which the aforementioned access may occur, the conditions under which such access can occur, the manner by which such access occurs (for example, whether civil security provisions are delivered to a given authorized beneficiary (and if so, when, how often, and so forth) or must be picked up by the authorized beneficiary from a given distribution point), and so forth.

As one example in this regard, differing access opportunities could comprise, at least in part, a first access opportunity that provides limited access to no more than a first amount of the civil security resources and a second access opportunity that provides limited access to more than the first amount of the civil security resources. In such a case, the first amount can be specified, if desired, as a function of a predetermined quantity of the civil security resources and/or as a function of a predetermined amount of time during which the civil security resources are accessed. As to the latter example, the second access opportunity could differ from the first access opportunity, at least part, by providing an opportunity to have access to the civil security resources at a time that is temporally subsequent to a time when the first access opportunity provides access to the civil security resources (to thereby provide, for example, for a resupply or replenishment opportunity that supplements an original stock of supplies as might correspond to what is provided pursuant to the first access opportunity).

This can comprise, if desired, additionally offering access opportunities that provide access to less than all three categories of the civil security resources noted. As a very simple illustration in this regard, a first access opportunity could provide limited access to only civil security provisions and civil security services while a second, different access opportunity could provide access to both these civil security resources and civil security facilities as well.

By one approach, for example, standard (or customizable) bundles of specific resources, fashioned in different ways, could comprise these different access opportunities. Again, a simple illustrative example may be useful in this regard (though the reader is cautioned that the provided example is but one example of an indeterminate number of possibilities and is not offered with any suggestion of exhaustion in this regard). Consider, in particular, five different access opportunities that are each generally characterized as follows:

A first access opportunity that provides limited access to only a limited selection of the civil security provisions and a limited selection of the civil security services comprising information-related services;

A second access opportunity that provides limited access to only a limited selection of the civil security provisions and a limited selection of the civil security services comprising both information-related services and transportation services (such as civilly-catastrophic event-based transportation to a civil security provisions distribution facility);

A third access opportunity that provides limited access to only a limited selection of the civil security provisions, a limited selection of the civil security services comprising information-related services and transportation services, and a limited selection of the civil security facilities comprising a civil security rally point (or, in other words, an access opportunity that equals that provided by the second access opportunity plus access to the civil security rally point);

A fourth access opportunity that equals that provided by the third access opportunity plus access to a civil security shelter (or shelters); and

A fifth access opportunity that equals that provided by the fourth access opportunity plus access to civil security rescue services.

If desired, a given provider of these civil security resources can provide five such access opportunities to comprise the primary offerings to be provided to the authorized beneficiaries. Each such offering can of course command a different corresponding level of consideration (such as, for example, a different corresponding payment to be proffered for each).

It would of course also be possible to permit an authorized beneficiary having a given one of these access opportunities to extend the scope of the opportunity in exchange for increased consideration. By one approach, such an extension (or upgrade) could be accommodated by simply requiring payment of a price differential as otherwise distinguishes such opportunities in the first instance. Such an approach might be appropriate, for example, when accommodating such a change well prior to even the threat of any particular civilly-catastrophic event. If desired, however, such an extension (or upgrade) might require a considerably higher supplemental payment when the authorized beneficiary seeks the extension (or upgrade) during or following a given civilly-catastrophic event and/or at a time when a given civilly-catastrophic event is perceived as being an imminent occurrence.

It would also be possible to permit some or all of the resources as comprise such an opportunity to be customized to suit the needs and/or preferences of a given authorized beneficiary. In some cases, such customization might be offered without additional corresponding cost. In other cases, and particularly where items and/or services of higher value are being substituted for existing standard items or services, additional commensurate cost might be required. For example, a given authorized beneficiary might wish to upgrade their unit of civil security provisions to include some foods that are not a part of a standard package of supplies or might wish to upgrade from a basic rescue package to a premier rescue offering that offers, for example, a faster guaranteed maximum response time.

If desired, this process will also optionally accommodate providing a key to authorized beneficiaries to thereby facilitate and permit those authorized beneficiaries to access one or more of the civil security resources during an authorized time of need. Such a key may comprise a physical item (such as, for example, an identification card or a physical lock key) and/or a non-physical item (such as, for example, a code such as a personal identification number, a password, or the like). When the key itself comprises a biometric characteristic as corresponds to the authorized beneficiary (such as, but not limited to, deoxyribonucleic acid (DNA), a retinal pattern, an asperity pattern (such as a fingerprint, a palm print, or the like), a voice print, a characteristic typing pattern, and so forth) this step can comprise (in conjunction with acquiring information, materials, and/or samples from the authorized beneficiary to thereby characterize the biometric of choice) providing instructions to the authorized beneficiary regarding presentation of such a biometric in order to gain the desired access. When the key comprises a code, by one approach this step can comprise providing the code to the authorized beneficiary. By another approach, this step can comprise receiving a code of choice from the authorized beneficiary and then providing confirmation to the authorized beneficiary regarding acceptance of that proffered code.

Those skilled in the art will appreciate the considerably flexibility and scalability that these teachings offer. As an example of such flexibility, by one approach, if desired, a base line membership for a given authorized beneficiary can bear a corresponding base line price and offer access to a corresponding set of civil security resources. These resources might comprise, for example:

Pre-civilly catastrophic event delivery of a short-term supply of survival resources comprising at least nutritional consumables. Hydration supplies can also be provided if desired. This short-term supply can comprise, for example, a sufficient quantity of survival resources to support survival of the corresponding authorized beneficiary for at least a predetermined number of days (such as, for example, a ten day period of time).

Pre-civilly catastrophic event access to civil security services comprising consulting services that provide for a preparedness review and inventory as well as preparation of a customized and personalized personal action plan to guide the authorized beneficiary in the event of a civilly-catastrophic event-based time of need.

A right to acquire additional civil security provisions (either for current delivery or to be held pending a civilly-catastrophic event-based time of need) and/or to access civil security facilities or additional services.

So configured, a given authorized beneficiary can obtain a viable, valuable, useful entrée into a private civil security paradigm. A base line offering can be provided for a relatively modest initial cost and, if and as the authorized beneficiary becomes more learned and experienced with respect to civil security issues and concerns, additional supplemental kinds and levels of protection and security can be subsequently acquired as needed.

Those skilled in the art will recognize and appreciate that the above described teachings can be applied and leveraged in a variety of ways to achieve a significant number of tangible and concrete benefits (including but not limited to facilitating a relatively higher degree of personal awareness regarding civil security issues, a relatively higher level of resources availability, and/or a relatively more powerful set of motivations for various parties to adopt behaviors that in turn prompt an increased availability of potentially life-preserving resources for a relatively wide consuming audience than might likely be achieved in the absence of such teachings).

It will be appreciated that these teachings provide for a highly flexible yet powerfully effective way by which a modern citizen can greatly improve their likelihood of surviving a civilly-catastrophic event. These teachings are sufficiently flexible so as to accommodate the needs and desires of a wide-ranging set of potential beneficiaries while nevertheless still tending to ensure adequate access to the basic necessities of life. Though training and some related activity may be provided and encouraged, in general the beneficiary receives these benefits without being required to make the commitment of time, energy, and expertise that would ordinarily be associated with attaining such a high level of civil security.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example in this regard, the notion of civil security provisions can encompass, if desired, weapons of various kinds. Weapons and their ammunition (including, but not limited to, projectile-based weapons of various kinds) can have an important place in ensuring one's survival under certain conditions as they can be used for protection and can also be employed for hunting.

I claim:

1. A computer program, preferably browser-based, to permit a privatized civil security beneficiary to input their zip code (or other postal code or the like) along with the number of people to be treated as beneficiaries and the square footage of their house or other building or facility of interest. With this input, the program can then provide a PCSR (Privatized Civil Security Ranking) that will list the probability and severity of a civilly-catastrophic event happening in that area within some given period of time. By one approach, this program can take into account other factors such as local population (density, characteristic representative demographics, or the like), climate and/or weather, geological studies and history, local businesses, industry, or utilities, and historical data of varying kinds. This program can then rank and specify the civil security provisions that are advisable and/or likely to be needed for the specified number of beneficiaries over various durations of time. This system might be tied to a manufacturing and/or member services network that will then create the proper supplies and wait for a consultant to help with storage, training, and/or corresponding implementation or training. Such an approach can account for the fact that different parts of the globe have different corresponding likely threats and allow for maximum amounts of the appropriate provisions to be at one's home. This program can also be used for travelers who wish to rent or otherwise take their own civil security provisions on a business trip, vacation, or extended stay. Such a program can use some or all of the same factors to rank the risk and/or relative preparedness of the hotel or area where such a beneficiary might be staying. By one approach, such a system could be contracted with hotels to provide preparedness rankings so that beneficiaries and potential beneficiaries can enjoy an increased likelihood of survival and/or comfort in the event of a civilly-catastrophic event.
